(19) United States
(12) Patent Application Publication
(10) Pub. No.: US 2007/0169138 A1
(43) Pub. Date: Jul. 19, 2007

(54) Lens actuator and optical pickup apparatus

(75) Inventor: Yasutaka Nakagaki, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA OPTO, INC.

(21) Appl. No.: 11/651,559

(22) Filed: Jan. 10, 2007

(30) Foreign Application Priority Data
Jan. 13, 2006 (JP) 2006-006213

(51) Int. Cl. G11B 7/00

(52) U.S. Cl. 720/683

(57) ABSTRACT

Disclosed in a lens actuator for an optical pickup apparatus, including: a movable holder to hold a lens; and an actuator to move the holder in a tracking direction and a focusing direction, wherein the actuator comprises a yoke and a magnet, and the holder contacts with the yoke before the holder contacts with the magnet, when the holder moves in the tracking direction.

### BACKGROUND OF THE INVENTION

1. Field of the Invention

The present invention relates to a lens actuator for an optical pickup apparatus and an optical pickup apparatus, particularly to a lens actuator and an optical pickup apparatus suitable for actuating an objective lens and the like.

2. Description of Related Art

Optical pickup apparatuses have been developed, which can record and/or reproduce information on an optical disk as typified by a CD and DVD. Also, development of an optical pickup apparatuses which can record/reproduce information on an optical disk such as a Blu-ray Disc and HD DVD by using blue-violet semiconductor laser of about 400 nm wavelength has been promoted rapidly. Regarding an objective lens of an optical pickup apparatus to form a focal spot, required are focusing operation to image a focal spot appropriately on an image recording surface of an optical disk in recording and/or reproducing information and tracking operation to follow a track of an optical disk appropriately.

For example, JP 2005-216357A discloses a lens actuator in which two wire suspension members in each side (four in total) support a lens holder with being capable of performing focusing operation, tracking operation and tilt operation. The suspension members have functions of elastically supporting the lens holder and of supplying electricity to generate magnetism required for each operation.

When a holder holding an objective lens is moved in a tracking direction in a lens actuator, it is necessary to provide a stopper for preventing the holder from moving over an allowable range. It may be possible that a holder contacts with a magnet of an actuator so as to function as a stopper, when the holder moves a predetermined distance. However, according to such structure, when the holder swiftly contacts with the magnet, defective operation may occur because the magnet may slide or drop from a yoke.

### SUMMARY OF THE INVENTION

The present invention has been made in consideration of the above problem, and it is one of objects of the present invention to provide a lens actuator and an optical pickup apparatus in which defective operation is prevented.

In order to attain the above object, according to a first aspect of the invention, a lens actuator for an optical pickup apparatus, comprises: a movable holder to hold a lens; and an actuator to move the holder in a tracking direction and a focusing direction, wherein the actuator comprises a yoke and a magnet, and the holder contacts with the yoke before the holder contacts with the magnet, when the holder moves in the tracking direction.

According to a second aspect of the invention, an optical pickup apparatus comprises: a lens actuator for an optical pickup apparatus, comprising a movable holder to hold a lens, and an actuator to move the holder in a tracking direction and a focusing direction; and a housing to fix the lens actuator, wherein the actuator comprises a yoke and a magnet, and the holder contacts with the yoke before the holder contacts with the magnet, when the holder moves in the tracking direction.

According to the lens actuator and optical pickup apparatus of the present invention, the actuator comprises the yoke and the magnet. When the holder moves in the tracking direction, the holder contacts with the yoke before it contacts with the magnet. Accordingly, since the holder is prevented from contacting with the magnet, it is possible to prevent the magnet from being slided or dropping from the yoke. Even when the magnet contacts with the holder after the holder contacts with the yoke, it is still advantageous because the impact on the contact is suppressed to some extent. However, it is preferable that the magnet does not contact with the holder.

Preferably in the lens actuator and optical pickup apparatus, a length of the yoke in the tracking direction is longer than a length of the magnet in the tracking direction.

Preferably in the lens actuator and optical pickup apparatus, an interval between the yoke and the holder in the tracking direction is shorter than an interval between the magnet and the holder.

Preferably in the lens actuator and optical pickup apparatus, the yoke and the magnet are disposed in an opening of the holder, and a width of the opening in the tracking direction is narrower at a position facing with the yoke than a position facing with the magnet.

Preferably in the lens actuator and optical pickup apparatus, in the opening, a protrusion is formed at a position facing with the yoke.

### BRIEF DESCRIPTION OF THE DRAWINGS

The present invention will become more fully understood from the detailed description given hereinbelow and the appended drawings which given by way of illustration only, and thus are not intended as a definition of the limits of the present invention, and wherein;

FIG. 1 is a perspective view of a lens actuator of the present embodiment;

FIG. 2 is a view around the magnet 10A and yoke 8A watching from the direction of arrow II in FIG. 1;

FIG. 3 is a similar view with FIG. 2, showing a modification of the present embodiment;

FIG. 4 is a similar view with FIG. 2, showing another modification of the present embodiment; and

FIG. 5 is a similar view with FIG. 2, showing another modification of the present embodiment.

### DETAILED DESCRIPTION OF THE PREFERRED EMBODIMENT

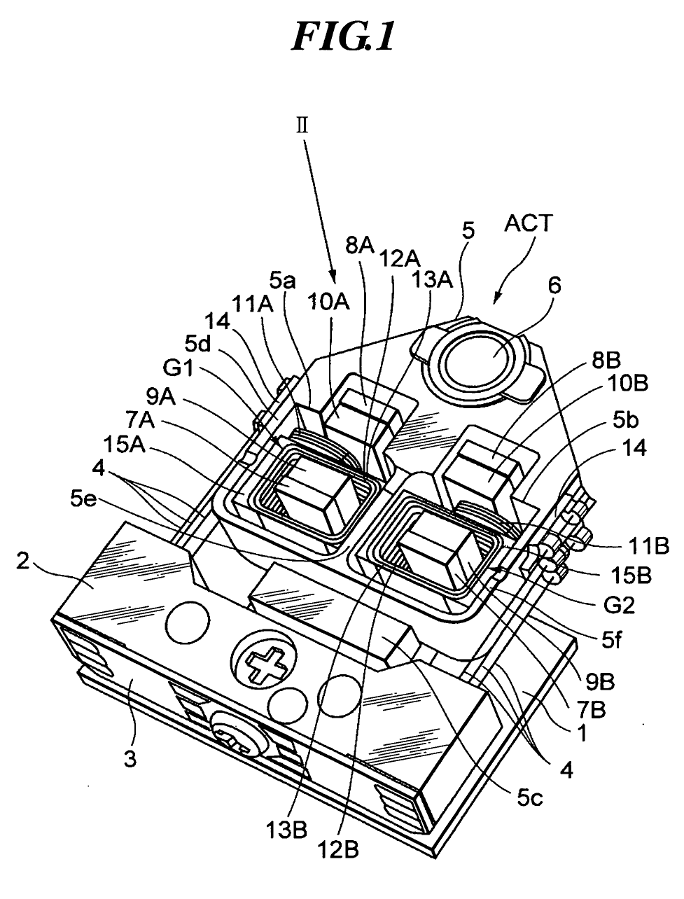

Hereinafter, the present invention is described in detain with reference to the drawings. FIG. 1 is a perspective view of a lens actuator of the present embodiment. A plate-like base 1 which also works as a yoke is fixed on a housing of an unillustrated optical pickup apparatus. A case 2 is fixed on the base 1. A base board 3 is attached on the front side of the case 2 in the figure. One ends of wires 4 are fixed on the base board 3, where the number of the wires 4 are three in each side and six in total. The wires 4 are aligned in each side in parallel at even interval in the vertical direction, and are laid along with the base 1. The other sides of the wires 4 are soldered or caukled on a side wall of a holder 5 through a holder base 14 made of glass epoxy. The wires 4 have functions of supporting the holder 5 movably with respect to the base 1 and of supplying electric power from the base board 3 to which an unillustrated wiring is connected to a coil described below. The case 2 is filled up with gel (not shown) having dumping effect.

The resin-made holder 5 has tabular shape of approximately pentagon, and an objective lens 6 is attached in a circular opening (not shown) located at the rear side in the figure. The objective lens 6 is used to focus a laser beam on a information recording surface of an optical disk in the optical pickup apparatus. The holder 5 forms two rectangular openings 5a and 5b at the front side in the figure, and has a balancer 5c adjacent to the rectangular openings 5a and 5b. It also can be said that the holder 5 couples the side of the objective lens 6 and the opposite side thereof by columns 5d and 5e disposed at both sides of the rectangular opening 5a and by columns 5e and 5f disposed at both sides of the rectangular opening 5b. According to such structure, it is possible to retain high rigidity of the holder 5 even when the cross section of the rectangular openings 5a and 5b are large. When the central axis of the shared column 5e located at the center intersects with the optical axis (and the extension thereof) of the objective lens 6, the holder 5 can achieve a good balance.

Inside the rectangular opening 5a, a pair of magnets 9A and 10A are disposed to be opposite to each other, where yokes 7A an 8A which are formed by folding a part of the base 1 adheres and supports the magnets 9A and 10A from the backside. A first coil assembly G1 (inner coil 12A and outer coil 13A) is disposed to wind around the magnet 9A and yoke 7A. A tracking coil 11A whose coil axis is perpendicular to that of the first coil assembly G1 is disposed between the first coil assembly G1 and magnet 10A.

Inside the rectangular opening 5b, a pair of magnets 9B and 10B are disposed to be opposite to each other, where yokes 7A an 8A which are formed by folding a part of the base 1 support the magnets 9B and 10B from the backside. A second coil assembly G2 (inner coil 12B and outer coil 13B) is disposed to wind around the magnet 9B and yoke 7B. A tracking coil 11B whose coil axis is perpendicular to that of the first coil assembly G2 is disposed between the second coil assembly G2 and magnet 10B. The first coil assembly G1 is attached to the rectangular opening 5a through a holder 15A holding the both sides thereof, and the second coil assembly G2 is attached to the rectangular opening 5b through a holder 15B holding the both sides thereof.

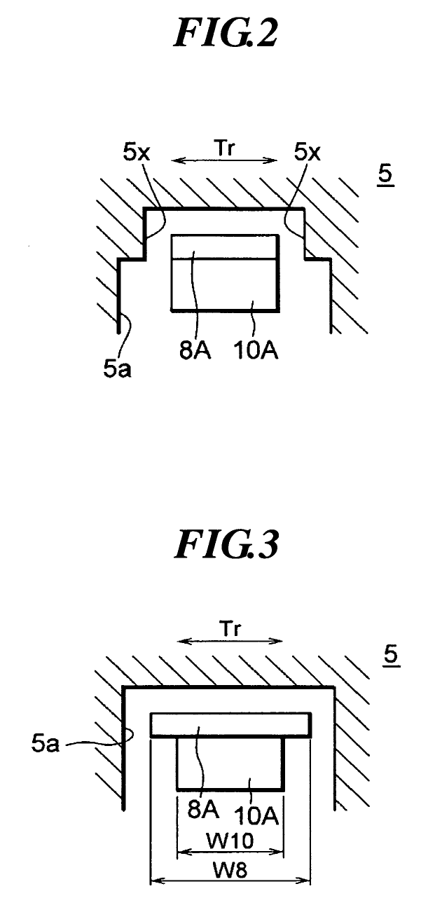

FIG. 2 is a view around the magnet 10A and yoke 8A watching from the direction of arrow II in FIG. 1. The rectangular opening 5a comprises steps 5x and 5x in both upper sides thereof in FIG. 2, and the width is narrower at the side of the objective lens. The steps 5x and 5x face with the yoke 8A in a tracking direction (shown by an arrow Tr in FIG. 2 or later), but do not face with the magnet 10A.

Next, operation of the lens actuator of the present embodiment is described. In FIG. 1, the direction of magnetic field across the outer coil 13A is same as that across the outer coil 13B. When electric power is supplied through the wire 4, the electric current flows in the same direction (clockwise direction in the figure) and the same current value between the outer coils 13A and 13B, and magnetism upward in the figure is generated in the outer coils 13A and 13B according to Fleming's left-hand rule. Accordingly, the holder 5 to which the first coil assembly G1 and second coil assembly G2 are fixed moves upwardly in the figure so that the objective lens 6 moves in the optical axis direction. Thus, a focusing operation can be realized. When the direction of the electric current flow reverses, the holder moves downward.

On the other hand, when electric current of clockwise direction is applied to the inner coil 12B, and that of anticlockwise direction to the inner coil 12B, magnetism upward in the figure is generated in the inner coil 12A and magnetism downward in the figure is generated in the inner coil 12B, according to Fleming's left-hand rule. Accordingly, a moment around its central axis acts on the holder 5. Thus, by tilting the holder 5 with the moment, tilt operation of the objective lens 6 can be realized. When electric current directions of the inner coils 12A and 12B are both clockwise direction and electric current directions of the outer coils 13A and 13B are different each other, it is advantageous that a clockwise magnetic circuit is formed and gap magnetic flux density increases.

Further, the holder 5 with the objective lens 6 can move in the direction perpendicular to the optical axis by applying electric current to the tracking coils 11A and 11B. Thus, tracking operation can be realized.

According to the present embodiment, when the holder 5 moves more than a predetermined distance in any tracking direction, the step 5x at the moving direction contacts with the opposing surface of the yoke 8A so as to work as a stopper. Thus, it is possible to prevent the holder 5 from moving more. On the other hand, since the step 5x does not directly contact with the magnet 10A, the magnet 10A is prevented from sliding or dropping out from the yoke 8A. The step may be or may not be provided at the rectangular opening 5b.

FIG. 3 is a similar view with FIG. 2, and shows a modification of the present embodiment. In this modification, the rectangular opening 5a does not form a step. Instead, the width W8 of the yoke 8A in the tracking direction is longer than the width W10 of the magnet 10A in the tracking direction, where the protrusion of the yoke 8A with respect to the magnet 10A is the same between the both sides thereof.

According to this modification, when the holder 5 moves more than a predetermined distance in any tracking direction, the side wall of the rectangular opening 5a at the moving direction contacts with the opposing surface of the yoke 8A so as to work as a stopper. Thus, the holder is prevented from moving more. On the other hand, the side wall of the rectangular opening 5a does not directly contact with the magnet 10A, the magnet 10A is prevented from sliding and dropping from the yoke 8A.

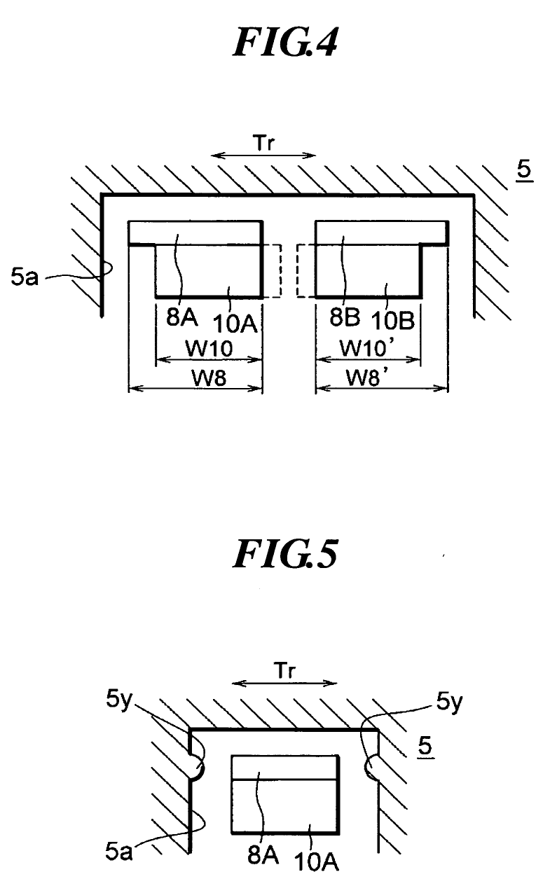

FIG. 4 is a similar view of FIG. 2 showing another modification of the present embodiment. According to the modification, a single opening 5a having no step is formed, and a yoke 8A, a magnet 10A, a yoke 8B and a magnet 10B are disposed in parallel. Here, the width W8 of the left yoke 8A in the tracking direction is longer than the width W10 of the magnet 10A in the tracking direction, and the yoke 8A protrudes only on left side with respect to the magnet 10A. On the other hand, the width W8′ of the right yoke 8B in the tracking direction is longer than the width W10′ of the magnet 10B in the tracking direction, and the yoke 8B protrudes only on the right side with respect to the magnet 10B.

According to this modification, when the holder 5 moves more than a predetermined distance in the right direction, the left-side wall of the rectangular opening 5a contacts with the opposing surface of the yoke 8A so as to work as a stopper. Thus, the holder 5 is prevented from moving more.

On the other hand, the side wall of the rectangular opening 5a does not directly contact with the magnet 10A, the magnet 10A is prevented from sliding and dropping from the yoke 8A. Further, when the holder 5 moves more than a predetermined distance in the left direction, the right-side wall of the rectangular opening 5a contacts with the opposing surface of the yoke 8B so as to work as a stopper. Thus, the holder 5 is prevented from moving more. On the other hand, the side wall of the rectangular opening 5a does not directly contact with the magnet 10B, the magnet 10B is prevented from sliding and dropping from the yoke 8B. Even when the width of the magnets 10A and 10B in the tracking direction is equal or longer than the width of the yoke 8A and 8B, similar advantage can be obtained by being the interval between the yokes 8A and 8B and the holer 5 shorter than the interval between the magnets 10A and 10B and the holder 5 (see the dashed line in FIG. 4).

FIG. 5 is a similar view with FIG. 2, showing another modification of the present embodiment. The modification is different from the embodiment of FIG. 2 in that semispherical protrusions 5y and 5y are provided to face with the yoke 8A instead of providing the steps with the rectangular opening 5a. According to this modification, when the holder 5 moves more than a predetermined distance in any direction, any of the protrusions 5y contacts with the opposing surface of the yoke 8A so as to work as a stopper. Thus, the holder 5 is prevented from moving more. On the other hand, the side wall of the rectangular opening 5a including the protrusion 5y does not directly contact with the magnet 10A, the magnet 10A is prevented from sliding and dropping from the yoke 8A.

Although the present invention is described with reference to the embodiment, the present invention is not limited to these embodiments and optional modification or alternation can be given. For example, the above-described embodiment and the modifications thereof can be carried out in combination.

The entire disclosure of Japanese Patent Application No. 2006-6213 filed on Jan. 13, 2006, including description, claims, drawings and summary are incorporated herein by reference.

What is claimed is:

1. A lens actuator for an optical pickup apparatus, comprising:
a movable holder to hold a lens; and
an actuator to move the holder in a tracking direction and a focusing direction,
wherein the actuator comprises a yoke and a magnet, and the holder contacts with the yoke before the holder contacts with the magnet, when the holder moves in the tracking direction.

2. The lens actuator of claim 1, wherein a length of the yoke in the tracking direction is longer than a length of the magnet in the tracking direction.

3. The lens actuator of claim 1, wherein an interval between the yoke and the holder in the tracking direction is shorter than an interval between the magnet and the holder.

4. The lens actuator of claim 1, wherein the yoke and the magnet are disposed in an opening of the holder, and a width of the opening in the tracking direction is narrower at a position facing with the yoke than a position facing with the magnet.

5. The lens actuator of claim 4, wherein in the opening, a protrusion is formed at a position facing with the yoke.

6. An optical pickup apparatus comprising:
a lens actuator for an optical pickup apparatus, comprising a movable holder to hold a lens, and an actuator to move the holder in a tracking direction and a focusing direction; and
a housing to fix the lens actuator,
wherein the actuator comprises a yoke and a magnet, and the holder contacts with the yoke before the holder contacts with the magnet, when the holder moves in the tracking direction.

7. The optical pickup apparatus of claim 6, wherein a length of the yoke in the tracking direction is longer than a length of the magnet in the tracking direction.

8. The optical pickup apparatus of claim 6, wherein an interval between the yoke and the holder in the tracking direction is shorter than an interval between the magnet and the holder.

9. The optical pickup apparatus of claim 6, wherein the yoke and the magnet are disposed in an opening of the holder, and a width of the opening in the tracking direction is narrower at a position facing with the yoke than a position facing with the magnet.

10. The optical pickup apparatus of claim 9, wherein in the opening, a protrusion is formed at a position facing with the yoke.
